(19) United States
(12) Patent Application Publication
(10) Pub. No.: US 2006/0062342 A1
(43) Pub. Date: Mar. 23, 2006

(54) Method and apparatus for the production of radioisotopes

(75) Inventors: Carlos E. Gonzalez Lepera, Houston, TX (US); Saverio R. Strangis, Pearland, TX (US)

Correspondence Address: VINSON & ELKINS L.L.P., 1001 FANNIN STREET, 2300 FIRST CITY TOWER, HOUSTON, TX, 77002-6760, US

(73) Assignee: Cyclotron Partners, L.P.

(21) Appl. No.: 10/943,283

(22) Filed: Sep. 17, 2004

(51) Int. Cl. G21G 1/10

(52) U.S. Cl. 376/195

(57) ABSTRACT

A target system includes a beam path for receiving a particle beam and a target chamber for housing a sample material. A target foil is operable for holding the sample material in the target chamber. A pressure cell is formed along a portion of the beam path between the target foil and a pressure foil. When irradiating the sample material with the particle beam, the pressure inside the target chamber and the pressure cell is increased and maintained at substantially the same pressure. A method includes inserting a sample material into a target chamber of a target system. The target system includes a pressure cell formed along a portion of a beam path between a pressure foil and a target foil, adjacent the target chamber. The pressure cell and the target chamber are pressurized and maintained at substantially the same pressure. The sample material is irradiated to produce a radioisotope.

### BACKGROUND OF THE INVENTION

1. Field of the Invention

This invention relates generally to the production of radioisotopes, and, more particularly, to a target system for irradiating a sample material by an accelerated particle beam.

2. Description of the Related Art

A radioisotope is an unstable element that releases radiation (energy in the form of particles or electromagnetic waves), while it decays into a stable element. The decay rate is usually referred to as the half-life of the element. Radioisotopes may be used in a number of different applications. Medical applications of radioisotopes may include, for example, imaging and measuring of physiological processes or the treatment of cancer.

Position Emission Tomography (PET) is one particular imaging application that uses radioisotopes. A PET procedure generally includes labeling a radiopharmaceutical with a radioactive isotope and then administering the radiopharmaceutical to a patient. The radioisotope decays inside the patient through the emission of positrons. The positrons are typically annihilated upon encountering electrons which produce oppositely directed gamma rays. A PET scanner may be used to detect the paths of the gamma rays, and this data is analyzed for diagnostic purposes.

Radioisotopes may be produced, for example, in a nuclear reactor or using a particle accelerator. With a particle accelerator, radioisotopes are produced by accelerating a particle beam and bombarding a sample material (e.g., liquid, solid, or gas), housed in a target system, with the particle beam. This process is usually referred to as irradiation or bombardment.

Particle accelerators generally operate by accelerating a certain number of particles per unit of time (i.e., beam current) up to a final energy. The beam extracted from the accelerator may be electromagnetically steered into a material holder, commonly referred to as a target system. For example, in one illustrative embodiment, a particle beam accelerator may be operated to generate a high energy 12 MeV proton beam that is steered to a target system for producing a nuclear reaction to generate a desired radioisotope. At an energy of 12 MeV, the resulting proton beam may have a beam current, for example, of approximately 10-20 μA. At the end of the irradiation, the sample material is removed from the target system and is processed into a final product.

As described, the desired sample material (e.g., sterile water) is held in a target system during irradiation. A typical target system includes one or more window foils positioned along a beam path. The window foils allow the beam from the accelerator to pass through the target system, while the last window foil maintains the sample material in a target chamber. In operation, the particle beam passes through the window foils and irradiates the sample material. Ordinarily, during irradiation, a cooling system is used to cool the target system and the sample material. A number of factors are often considered when designing a target system, such as beam power dissipation, temperature, pressure, chemical inertness, remote transfer, residual radiation of the sample material, etc.

Typically, in a target system, two window foils are used in such a way that the target system is divided into three sections along its beam path. In this illustrative embodiment, the first section is ordinarily under vacuum. A cooling fluid, such as helium is passed through the second section, and the third section includes the target chamber housing the sample material being irradiated. For simplicity, the first window foil along the beam path may be referred to as the vacuum foil, and the second window foil may be referred to as the target foil.

Unfortunately, during operation, the window foils of the target system absorb a portion of the beam power, and this energy is converted into heat. The absorption of the beam power is typically directly proportional to the thickness of the window foil. In addition, the sample material and the target foil are usually subjected to elevated pressures during irradiation. That is, the pressure in the target chamber is usually elevated during irradiation to increase the boiling temperature of the sample material. When the pressure is increased in the target chamber, a pressure differential is created across the target foil that, along with the energy absorbed during irradiation, places the target foil under a great deal of stress. This stress may cause the target foil to rupture or otherwise fail during irradiation.

To expedite the irradiation process, it is generally desirable to increase the target chamber pressure and the beam energy up to the limits of the target foil. Beam energy and target chamber pressure limits are functions of target foil thickness. For example, if the thickness of the target foil is increased, the target chamber pressure may be increased advantageously raising the boiling point of the sample material. Unfortunately, if the thickness of the target foil is increased, the beam energy absorbed during irradiation also increases resulting in undesirable heating of the target foil. To minimize absorption heat, it is preferable to minimize the thickness of the target foil, but thinner target foils require a sacrifice in operating pressure in the target chamber (i.e., thinner target foils limit the operating pressure of the target chamber).

A number of considerations have been attempted to reduce window foil stress. One approach is to introduce a perforated grid to support the target foil. This approach is described, for example, in U.S. Pat. No. 6,359,952 the contents of which are herby incorporated by reference. The perforated grid allows the target chamber pressure to be increased without having to substantially increase the thickness of the target foil. Unfortunately, the grid is not fully transparent, and a significant portion of the beam energy is absorbed and left in the grid.

Another approach used to reduce window foil stress is to implement the target chamber at an angle with respect to the beam direction. In this manner, beam power is distributed over a larger area reducing the power density on the target foil and sample material. Unfortunately, due to the increase in target foil surface area exposed to the particle beam, the beam power lost on the foil is increased. In addition, because of the increase in surface area, the target foil may withstand less pressure.

Typical PET radioisotopes, such as ¹⁸F, ¹³N and ¹¹C, have a very short half-life. Therefore, the radioisotope is ordinarily produced immediately before being administered to the patient. PET and other such applications have perpetuated an increase in the demand for radioisotopes. Accordingly, it is becoming necessary to optimize the irradiation process in order to increase the production rate and reduce the costs. What is needed, therefore, is a target system that provides for increased pressures in the target chamber, while minimizing the energy lost in the target foil.

The present invention is directed to overcoming, or at least reducing the effects of, one or more of the problems set forth above.

### SUMMARY OF THE INVENTION

In one aspect of the invention, a target system is provided. The target system includes a beam path for receiving a particle beam. A target body is positioned along the beam path and includes a target chamber and a target foil. The target chamber is operable for housing the sample material. The target foil is positioned proximate the target chamber and is operable for holding the sample material in the target chamber. A pressure foil is positioned along the beam path at least some distance before the target foil. A pressure cell is formed along a portion of the beam path between the pressure foil and the target foil, and when irradiating the sample material with the particle beam, the pressure inside the target chamber and the pressure cell is increased and maintained at substantially the same pressure.

In another aspect of the present invention, a method is provided. The method includes inserting a sample material into a target chamber of a target system. The target system includes a pressure foil and a target foil positioned along a beam path of the target system. A pressure cell is formed along a portion of the beam path between the pressure foil and the target foil. The target foil is operable for holding the sample material in the target chamber. The pressure cell and the target chamber are pressurized and maintained at substantially the same pressure. The sample material is irradiated to produce a radioisotope.

### BRIEF DESCRIPTION OF THE DRAWINGS

The invention may be best understood by reference to the following description taken in conjunction with the accompanying drawings, in which like reference numerals identify like elements, and in which:

FIG. 1 illustrates a target system in accordance with one illustrative embodiment of the present invention; and

FIG. 2 illustrates a simplified block diagram of a method in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a develop-ment effort might be complex and time-consuming, but would nevertheless be a routine undertaking for those of ordinary skill in the art having the benefit of this disclosure.

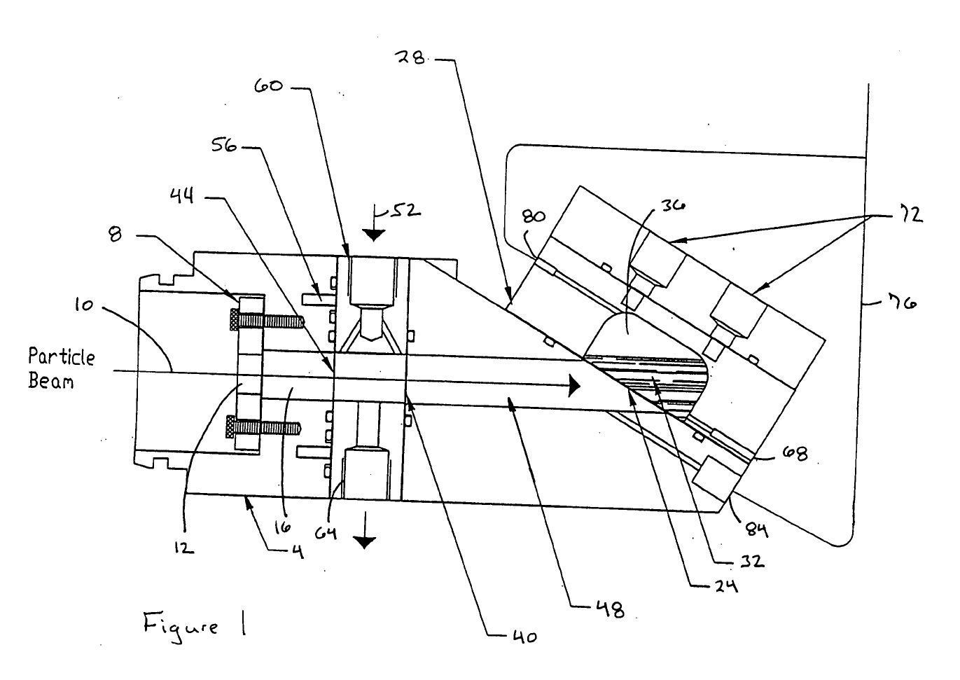

Referring to FIG. 1, a target system 4 in accordance with one embodiment of the present invention is shown. The target system 4 is operable with a particle beam accelerator (not shown) to produce radioisotopes. In this illustrative example, the target system 4 is coupled to a collimator 8 that receives a particle beam 10 from a particle accelerator. The collimator 8 includes a beam path 12 that, in this illustrative configuration, communicates with a beam path 16 of the target system 4. When irradiating a sample material, a particle beam 10 travels left-to-right, from the accelerator, through the collimator 8, and finally into the target system 4.

Continuing with this illustrative example, the beam path 16 of the target system 4 is divided by three window foils. A first window foil 24 is coupled to a target body 28. The target body 28 holds a sample material 32 in a target chamber 36 during irradiation. For convenience, the first window foil 24 shall be referred to as the target foil. In describing the present invention, the target foil 24 shall be considered the window foil holding the sample material 32 in the target chamber 36. As will be described below, the target system 4 may be provided with additional window foils depending upon the particular application of the present invention.

The thickness and composition of the target foil 24 may vary as a matter of design choice. Generally, the selected thickness depends on the particular application. The selected thickness may range, for example, between 0.0005 to 0.001 inches. In this example, the target foil 24 has a thickness of approximately 0.0005 inches. The target foil 24 may be comprised of any number of different materials. For example, the target foil 24 may be comprised of titanium, niobium, an alloy, such as Havar, or any other suitable material.

The target chamber 36 and the target foil 24 are fixed at an angle to the beam path 16, so that the current density of the particle beam 10 is spread over a larger surface area of the target foil 24. This position also increases the volume of sample material 32 subjected to the particle beam 10 and advantageously forces the sample material 32 on top of the target foil 24. However, it should be appreciated that the target chamber 36 and the target foil 24 may be fixed in any number of different positions with respect to the beam path 16, including a perpendicular position. Moreover, the exact position or angle of the target chamber 36 and target foil 24 may vary as a matter of design choice.

Second and third window foils 40, 44 are also shown along the beam path 16 of the target system 4. In this illustrative example, the second and third window foils 40, 44 are positioned substantially perpendicular to the beam path 16. It should be appreciated, however, that these window foils 40, 44, as was described for the target foil 24, may be placed in any number of positions or angles with respect to the beam path 16 and that the exact position may vary as a matter of design choice. To simplify the description of the present invention, the second window foil 40 may be referred to as the pressure foil. Moreover, the portion of the beam path 16 positioned between the pressure foil 40 and the target foil 24 may be referred to as a pressure cell 48.

In this example, the third window foil 44 is positioned a selected distance from the pressure foil 40, so that a cooling agent 52 may be passed between the third window foil 44 and the pressure foil 40. For the purpose of illustration, the third window foil 44 may be referred to as the vacuum foil. The cooling agent 52 functions to extract heat deposited on the vacuum foil 44 and the pressure foil 40 during irradiation. In addition, cooling channels 56 may be selectively provided to remove heat from the target system 4.

A number of different cooling agents 52 may be used with the target system 4. In one illustrative embodiment, helium is used as the cooling agent 52. The helium is injected into the target system 4 through a first flange 60. The helium is passed between the vacuum and pressure foils 44, 40, and exits the system 4 through a second flange 64. Although not shown, a recirculation system may be coupled to the first and second flanges 60, 64, and the recirculation system may be operated to loop the cooling agent 52 back through the target system 4, thus continually cooling the vacuum and pressure foils 44, 40 during irradiation.

A vacuum is ordinarily created on the opposing side of the vacuum foil 44 (i.e., the left side of the vacuum foil 44 in FIG. 1). This vacuum zone is typically continued down the beam path 16 to the particle beam accelerator. During irradiation, the beam 10 passes through the vacuum foil 44, then through the pressure foil 40, and finally through the target foil 24 to reach the sample material 32. If, however, cooling of the pressure foil 40 is not desired, the target system 4 may be provided without the vacuum foil 44. In this illustrative example, the vacuum may be created on the opposing side of the pressure foil 40, opposite the pressure cell 48.

As described, the target body 28 and the target foil 24 is positioned at an angle with respect to the beam path 16. The target body 28 may be provided with an opening 68 so that the sample material 32 may be inserted into the target chamber 36. Once irradiated, the radioisotope may also be extracted from the target chamber 36 through the same opening 68. In one illustrative embodiment, the target chamber 36 has a volume of approximately 3 to 3.5 cm³, and the volume of sample material 32 is approximately 1 to 2 cm³. It should be appreciated, however, that the volume of the sample material 32 and the mechanism or method of inserting or extracting the sample material 32 from the target chamber 36 should not be considered a limitation of the present invention.

The target body 28 may also be provided with channels, openings, or similar type passages 72 that allow a cooling agent to be passed through or over the target body 28. This cooling agent may be the same or different from the cooling agent 52 used to extract heat from the vacuum foil 44 and the pressure foil 40. During irradiation, the sample material 32 may be continuously evaporated by the beam power and condensates at the cooled walls of the target chamber 36.

To minimize the stress exerted on the target foil 24 during irradiation, a pressure line 76 may be coupled to the target chamber 36 and the pressure cell 48. It should be appreciated that any number of different configurations may be used to make these connections. In this illustrative embodiment, the pressure line 76 is coupled to an opening 80 in the target body 28. The opening 80 passes through the target body 28 and communicates with the target chamber 36. Likewise, the pressure line 76 is also coupled to an additional opening 84 in the target system 4. This opening 84 passes through the target system 4 and communicates with the pressure cell 48. Although not shown, any number of valves, gauges, sight glasses, instrumentation, or other intermediate type devices may be placed along the pressure line 76. Regardless of the selected configuration, the pressure line 76 should be coupled to the target system 4 in such a way that it communicates with both the target chamber 36 and the pressure cell 48.

Although not shown, a pump, pressurizing tank or other pressure-generating device may be coupled to the pressure line 76. The pressure-generating device is typically coupled to the pressure line 76 in such a manner that the pressure exerted in the line may be selectively and controllably determined. For example, flow valves, pressure valves, and other types of pressure instrumentation may be used to selectively set the pressure in the line 76. When pressurized, using, for example, an inert gas, the pressure line 76 causes the target chamber 36 and the pressure cell 48 to attain approximately the same pressure, thus substantially reducing the pressure stress experienced by the target foil 24. In other words, the pressure differential across the target foil 24 is substantially reduced because the target chamber 36 and pressure cell 48 are maintained at approximately the same pressure.

During irradiation, the target chamber 36 may be operated at a number of different pressures. In one illustrative embodiment, the pressure line 76 is operable to pressurize the target chamber 36 to between 500 and 1000 PSI. This increase in pressure raises the boiling point of the sample material 32 being irradiated and also increases the cooling capacity of the cooling agent passed over the target body 28. That is, the increased pressure in the target chamber 36 allows the target system 4 to operate at higher temperatures, resulting in a greater temperature differential between the cooling agent and the target body 28.

Although not shown, to reduce the pressure differential experienced by the pressure foil 24, one or more additional window foils may be positioned along the beam path 16 between the pressure foil 40 and the target foil 24. In this configuration, multiple pressure cells may be created that provide a mechanism for gradually reducing the pressure between the target foil 24 and the pressure foil 40. For example, the additional pressure cells may be coupled to the pressure line 76. Pressure valves may be placed along the pressure line before the additional pressure cells. These pressure valves may be coupled to a computer or other type of control device, so that the pressure in each successive pressure cell may be selectively and gradually reduced. Alternatively, the pressure valves may be manually operated.

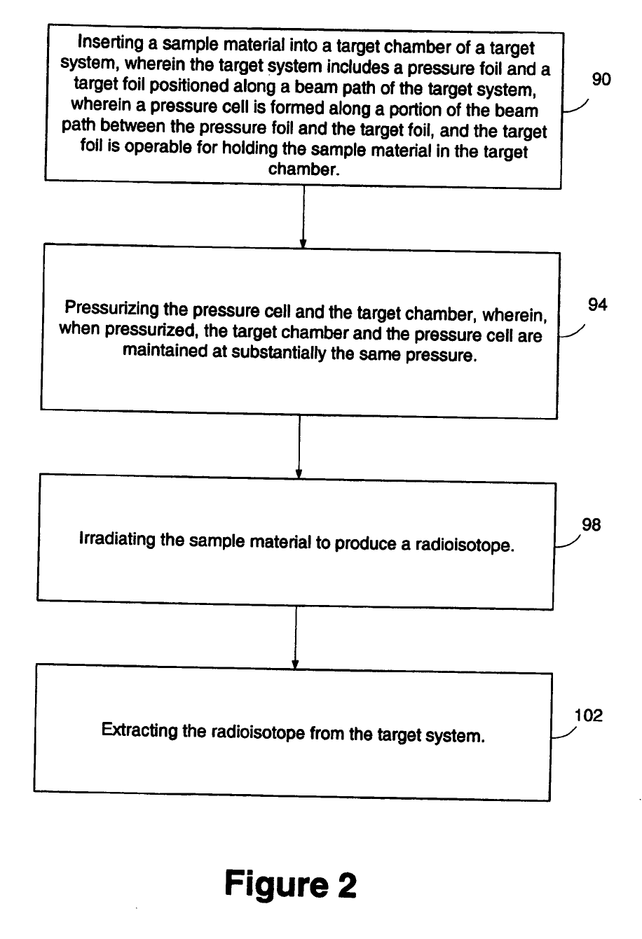

Referring to FIG. 2, a method for producing radioisotopes is shown. This process is discussed with reference to the target system 4, illustrated in FIG. 1, to simplify the discussion of the present invention. It should be appreciated, however, that alternative embodiments of the target system 4 and other system components might be used with the described method.

At block 90, a sample material 32 is inserted into a target chamber 36 of a target system 4. The target system 4 includes a pressure foil 40 and a target foil 24 positioned along a beam path 16 of the target system 4. A pressure cell 48 is formed in the portion of the beam path 16 between the pressure foil 40 and the target foil 24. The target foil 24 is operable for holding the sample material 32 in the target chamber 36.

As described, the sample material 32 may vary as a matter of design choice. Moreover, a number of different configurations and implementations may be used to insert the sample material 32 into the target chamber 36. In one illustrative embodiment, sterile water is inserted as the sample material 32. Although FIG. 1 shows two openings 68, 80 in the target body 28, one for inserting the sample material 32 and another for coupling the pressure line 76 to the target chamber 36, it should be appreciated that one opening may serve both purposes and that valves and other control devices may be used to facilitate such an embodiment of the present invention.

At block 94, a pressure line 76 coupled to both the pressure cell 48 and the target chamber 36 is pressurized. When pressurized, the target chamber 36 and the pressure cell 48 are maintained at substantially the same pressure. The pressurization may be facilitated using, for example, an inert gas, such as argon, helium, etc. Moreover, it should be appreciated that a wide variety of different hardware and control configurations may be used to initiate, deliver, and maintain the pressure cell 48 and the target chamber 36 at substantially the same pressure.

Regardless of the design choice selected, when pressurized, the pressure cell 48 and the target chamber 36 are maintained at substantially the same pressure. It is possible, however, that some fluctuation or pressure differential may still exist between the target chamber 36 and the pressure cell 48. This difference in pressure may be caused by, for example, calibration of control equipment, temperature changes resulting in expansion and contraction of the target system 4, leakage through the pressure foil 40 or target foil 24, transient conditions during pressure buildup, cooling fluctuations, differences in pressure line length, and similar type considerations.

As previously described, additional window foils may be positioned between the pressure foil 40 and the target foil 24. Such a configuration may be used to create a plurality of pressure cells along the beam path 16 of the target system 4. These additional pressure cells may be coupled to the pressure line 76, and the pressure selectively determined to gradually step-down the pressure moving away from the target foil 24. Under this approach, the additional pressure cells are operable to reduce the pressure differential experienced by the pressure foil 40.

At block 98, once the target chamber 36 and the pressure cell 48 are pressurized, the sample material 32 is irradiated to produce a radioisotope. During irradiation, a particle beam 10 is generated by a particle accelerator, and in the example shown in FIG. 1, the beam 10 passes through the vacuum foil 44, then through the pressure foil 40, and finally through the target foil 24 striking the sample material 32. In one example, a beam having a beam power of approximately 1.1 kW and a beam energy of approximately 15 MeV may be generated producing a beam current of approximately 72 μA. Using sterile water as the sample material 32, the reaction ¹⁶O(p,a)¹³N may be generated producing the radioisotope ¹³N. In this example, the half-life of ¹³N is approximately 9.96 minutes. In a similar manner, this process may be used to produce the radioisotopes ¹⁸F through ¹⁸O(p,n)¹⁸F.

At block 102, once the sample material 32 is irradiated, the radioisotope may be extracted from the target system 4. In one illustrative embodiment, prior to extracting the radioisotope, the pressure line 76 may be depressurized reducing the elevated pressures inside the target chamber 36 and the pressure cell 48. Alternatively, the target chamber 36 may remain fully or partially pressurized when extracting the radioisotope so that the sample material may be forced out an opening in the target body 28. It should be appreciated that a variety of different methods and configurations may be used to extract the radioisotope from the target system 4 and that the particular selection should not be considered a limitation of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A target system, comprising:
a beam path for receiving a particle beam;
a target body positioned along the beam path, wherein the target body includes:
a target chamber for housing a sample material;
a target foil positioned proximate the target chamber, wherein the target foil is operable for holding the sample material in the target chamber; and
a pressure foil positioned along the beam path at least some distance before the target foil, wherein a pressure cell is formed along a portion of the beam path between the pressure foil and the target foil, and when irradiating the sample material with the particle beam, the pressure inside the target chamber and the pressure cell is increased and maintained at substantially the same pressure.

2. The target system of claim 1, further comprising:
a first opening in the target system that communicates with the target chamber;
a second opening in the target system that communicates with the pressure cell, wherein the first opening and the second opening are coupled to a pressure line, and when irradiating the sample material, the pressure line is operable for increasing and maintaining the pressure inside the target chamber and the pressure cell at substantially the same pressure.

3. The target system of claim 2, further comprising:
at least one control device coupled to the pressure line, wherein the at least one control device is operable for controllably and selectively determining the pressure inside the pressure cell and the target chamber.

4. The target system of claim 1, wherein, when irradiating the sample material, the target chamber and the pressure cell are operated at a pressure of approximately 500 to 1000 PSI.

5. The target system of claim 1, wherein the target foil is positioned at an angle with respect to the beam path of the target system.

6. The target system of claim 1, wherein the target chamber has a volume of approximately 3 to 3.5 cm³.

7. The target system of claim 1, wherein the sample material has a volume of approximately 1 to 2 cm³.

8. The target system of claim 1, wherein the target foil is comprised of at least one of the group of titanium, niobium, and Havar.

9. The target system of claim 1, wherein the target foil has a thickness of approximately 0.0005 to 0.001 inches.

10. The target system of claim 1, further comprising:
a vacuum foil positioned along the beam path at least some distance before the pressure foil, wherein, when irradiating the sample material, a vacuum is maintained along a portion of the beam path preceding the vacuum foil, and a cooling agent is passed between the vacuum foil and the pressure foil to extract heat deposited by the particle beam on the vacuum foil and the pressure foil.

11. The target system of claim 1, further comprising:
at least one additional window foil positioned between the pressure foil and the target foil, wherein the at least one additional window foil forms a plurality of pressure cells positioned along the beam path between the pressure foil and the target foil, and the pressure inside each of the plurality of pressure cells is selectively determined so that a pressure cell adjacent to the target chamber and bordered by the target foil is maintained at substantially the same pressure as the target chamber, and the pressure inside the other pressure cells is gradually reduced to minimize a pressure differential exerted on the pressure foil.

12. The target system of claim 11, further comprising:
a plurality of openings in the target system, wherein at least one of the plurality of openings communicates with the plurality of pressure cells and at least one of the plurality of openings communicates with the target chamber, wherein the plurality of openings are coupled to a pressure line that is cooperatively operable with at least one pressure control device for controllably and selectively determining the pressure inside each of the plurality of pressure cells and the target chamber.

13. A method, comprising:
inserting a sample material into a target chamber of a target system, wherein the target system includes a pressure foil and a target foil positioned along a beam path of the target system, wherein a pressure cell is formed along a portion of the beam path between the pressure foil and the target foil, and the target foil is operable for holding the sample material in the target chamber;
pressurizing the pressure cell and the target chamber, wherein, when pressurized, the target chamber and the pressure cell are maintained at substantially the same pressure; and
irradiating the sample material to produced a radioisotope.

14. The method of claim 13, further comprising:
extracting the radioisotope from the target system.

15. The method of claim 13, wherein pressurizing the pressure cell and the target chamber comprises pressurizing the pressure cell and the target chamber to approximately 500 to 1000 PSI.

16. The method of claim 13, wherein the target system includes a vacuum foil positioned along the beam path before the pressure foil, and irradiating the sample material further includes:
evacuating a portion of the beam path preceding the vacuum foil; and
passing a cooling agent between the vacuum foil and the pressure foil to extract heat deposited by a particle beam on the vacuum foil and the pressure foil.

17. The method of claim 13, wherein inserting the sample material into the target chamber comprises positioning the target foil at an angle with respect to the beam path and inserting the sample material into the target chamber so that the sample material contacts the target foil.

18. The method of claim 13, wherein the target system includes a first opening that communicates with the target chamber, and a second opening that communicates with the pressure cell, and the first and second openings are coupled to a pressure line, wherein pressurizing the pressure cell and the target chamber comprises:
pressurizing the pressure line, wherein the pressure line is coupled to at least one pressure control device that is operable to controllably and selectively determine the pressure in the target chamber and the pressure cell.

19. The method of claim 13, wherein the sample material is sterile water, and irradiating the sample material comprises:
irradiating the sterile water with a particle beam having a beam power of approximately 1.1 kW and a beam energy of approximately 15 MeV to produce at least one of the group of ¹³N and ¹⁸F through ¹⁸O(p,n)¹⁸F.

20. A system, comprising:
a particle accelerator;
a target system coupled to the particle accelerator, wherein the target system includes:
a beam path for receiving a particle beam from the particle accelerator;
a target body positioned along the beam path, wherein the target body includes:
a target chamber for housing a sample material;
a target foil positioned proximate the target chamber, wherein the target foil is operable for holding the sample material in the target chamber; and
a pressure foil positioned along the beam path at least some distance before the target foil, wherein a pressure cell is formed along a portion of the beam path between the pressure foil and the target foil, and when irradiating the sample material with the particle beam, the pressure inside the target chamber and the pressure cell is increased and maintained at substantially the same pressure.

21. The system of claim 20, further comprising:
a collimator positioned between the particle accelerator and the target system, wherein the collimator is operable for collimating a particle beam generated by the particle accelerator before the particle beam enters the target system.

22. The system of claim 20, further comprising:
a first opening in the target system that communicates with the target chamber;
a second opening in the target system that communicates with the pressure cell, wherein the first opening and the second opening are coupled to a pressure line, and when irradiating the sample material, the pressure line is operable for increasing and maintaining the pressure inside the target chamber and the pressure cell at substantially the same pressure.

23. The system of claim 22, further comprising:
at least one control device coupled to the pressure line, wherein the at least one control device is operable for controllably and selectively determining the pressure inside the pressure cell and the target chamber.

24. The target system of claim 20, wherein the target foil is positioned at an angle with respect to the beam path of the target system.

25. The target system of claim 20, wherein the target foil is comprised of at least one of the group of titanium, niobium, and Havar.

26. The target system of claim 20, wherein the target foil has a thickness of approximately 0.0005 to 0.001 inches.

27. The target system of claim 20, further comprising:
a vacuum foil positioned along the beam path at least some distance before the pressure foil, wherein, when irradiating the sample material, a vacuum is maintained along a portion of the beam path preceding the vacuum foil, and a cooling agent is passed between the vacuum foil and the pressure foil to extract heat deposited by the particle beam on the vacuum foil and the pressure foil.
